(19) United States
(12) Patent Application Publication
(10) Pub. No.: US 2008/0265201 A1
(43) Pub. Date: Oct. 30, 2008

(54) LOW-TEMPERATURE-CURABLE POLYURETHANE COMPOSITIONS WITH URETDIONE GROUPS, CONTAINING POLYMERS BASED ON POLYOLS THAT CARRY SECONDARY OH GROUPS

(75) Inventors: Emmanouil Spyrou, Schermbeck (DE); Corey King, (US); Werner Grenda, Herne (DE); Christoph Lammers, Recklinghausen (DE); Rainer Lomolder, Munster (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/744,053

(22) Filed: May 3, 2007

(30) Foreign Application Priority Data
Apr. 26, 2007 (DE) 102007020168.2

(51) Int. Cl. C08G 18/02; C14C 11/00

(52) U.S. Cl. 252/8.57; 106/287.25; 524/590; 525/453; 528/45

(57) ABSTRACT

Low-temperature-curable polyurethane compositions with uretdione groups, containing polymers based on polyols that carry secondary OH groups.

The invention relates to polyurethane compositions with uretdione groups that cure at low baking temperatures, to processes for preparing such compositions and to their use for producing plastics, especially coatings and adhesives.

Externally or internally blocked polyisocyanates are valuable crosslinkers for thermally crosslinkable polyurethane (PU) coating and adhesive compositions.

For example, DE-A 27 35 497 describes PU coatings having outstanding weathering stability and thermal stability. The crosslinkers whose preparation is described in DE-A 27 12 931 are composed of ε-capro-lactam-blocked isophorone diisocyanate containing isocyanurate groups. Also known are polyisocyanates which contain urethane, biuret or urea groups and whose isocyanate groups are likewise blocked.

The drawback of these externally blocked systems lies in the elimination of the blocking agent during the thermal crosslinking reaction. Since the blocking agent may thus be emitted to the environment, it is necessary on environmental and workplace hygiene grounds to take particular measures to clean the outgoing air and/or to recover the blocking agent. The crosslinkers, moreover, are of low reactivity. Curing temperatures above 170° C. are required.

DE-A 30 30 539 and DE-A 30 30 572 describe processes for preparing polyaddition compounds which contain uretdione groups and whose terminal isocyanate groups are irreversibly blocked with monoalcohols or monoamines. Particular drawbacks are the chain-terminating constituents of the crosslinkers, which lead to low network densities in the PU coatings and hence to moderate solvent resistances.

Hydroxyl-terminated polyaddition compounds containing uretdione groups are subject matter of EP 669 353. On account of their functionality of two, they exhibit improved resistance to solvents. Compositions based on these polyisocyanates containing uretdione groups share the feature that, during the curing reaction, they do not emit any volatile compounds. At not less than 180° C., however, the baking temperatures are situated at a high level.

The use of amidines as catalysts in PU coating compositions is described in EP 803 524. Although these catalysts do lead to a reduction in the curing temperature, they exhibit a considerable yellowing, which is generally unwanted in the coatings sector. The cause of this yellowing is presumed to be the reactive nitrogen atoms in the amidines. They are able to react with atmospheric oxygen to form N-oxides, which are responsible for the discoloration.

EP 803 524 also mentions other catalysts which have been used to date for this purpose, but does not indicate any particular effect on the cure temperature. Such catalyst include the organometallic catalysts known from polyurethane chemistry, such as dibutyltin dilaurate (DBTL), or else tertiary amines, such as 1,4-diazabicyclo[2.2.2]octane (DABCO), for example. Quaternary ammonium salts are described in EP 1 334 987 and 1 475 399, for example, as catalysts for high-reactivity, uretdione-containing powder coating formulations.

Reactivity and storage stability are in principle causally dependent on one another. In accordance with the Arrhenius equation the following relationship exists: the higher the reactivity, the lower the storage stability, and vice versa. Although conventional high-reactivity powder coating formulations can be cured at low temperatures, they have the drawback of an unfavourable balance between reactivity and storage stability.

It was an object of the present invention, therefore, to find high-reactivity polyurethane compositions with uretdione groups that exhibit a more favourable balance between reactivity and storage stability.

Surprisingly it has been found that certain hydroxyl-containing polymers, which are based on at least one diol or polyol having at least one secondary OH group and whose fraction is at least 2 mol %, based on the alcohols employed, ensure a significantly better balance between reactivity and storage stability.

The present invention provides high-reactivity polyurethane compositions with uretdione groups, essentially containing
A) at least one curing agent with uretdione groups which is based on aromatic, aliphatic, (cyclo)aliphatic or cycloaliphatic polyisocyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
   such that the fraction of the catalyst under C) is 0.001-5% by weight, based on the overall formulation
D) if desired, at least one compound which is reactive towards acid groups and has a weight fraction, based on the overall formulation, of from 0.1% to 10%,
E) if desired, at least one acid in monomeric or polymeric form, in a weight fraction, based on the overall formulation, of from 0.01% to 20%,
F) if desired, auxiliaries and additives.

The invention further provides a process for preparing the polyurethane compositions.

The invention also provides for the use of the polyurethane compositions of the invention for producing powder coating compositions on metal, plastic, glass, wood, MDF (medium-density fibreboard) or leather substrates or on other heat-resistant substrates.

The invention also provides for the use of the polyurethane compositions of the invention as adhesive compositions for adhesive bonds of metal, plastic, glass, wood, MDF (medium-density fibreboard) or leather substrates or of other heat-resistant substrates.

Likewise provided by the invention are metal-coating compositions, particularly for automobile bodies, motorbikes and cycles, architectural components and household appliances, wood-coating compositions, MDF coatings, glass-coating compositions, leather-coating compositions and plastics-coating compositions.

The polyurethane compositions of the invention are highly reactive. This means that even at 120 to 160° C. the polyurethane compositions cure within from 5 to 30 minutes.

Furthermore, as compared with noninventive polyurethane compositions, the polyurethane compositions of the invention exhibit a significantly better balance between reactivity and storage stability. High reactivity in polyurethane compositions leads to the increased conversion of reactive groups, which in turn leads to a denser polymer network. In powder coatings, this network results in increased mechanical strengths, such as in higher ball impact values, for example. Improved storage stability, in contrast, can be recognized by the fact that the mechanical strengths do not deteriorate on storage and, additionally, by the fact that the levelling shows no substantial impairment as compared with noninventive compositions.

This means that powder coating materials based on polyurethane compositions of the invention, before and/or after storage at 40° C., exhibit a ball impact (ASTM D2794-93, direct and/or indirect) better by at least 30%, and/or a better levelling, higher by at least 2 units on the PCI scale, than noninventive polyurethane compositions under otherwise comparable conditions (in particular, comparable catalysis, acid content, and glass transition point of the components).

All of these advantageous properties of the polyurethane compositions of the invention are documented in the examples.

The curing agents A) with uretdione groups are obtained from polyisocyanates containing uretdione groups and from hydroxyl-containing monomers or polymers.

Polyisocyanates containing uretdione groups are well known and are described in, for example, U.S. Pat. No. 4,476,054, U.S. Pat. No. 4,912,210, U.S. Pat. No. 4,929,724 and EP 417 603. A comprehensive review of industrially relevant processes for dimerizing isocyanates to uretdiones is offered by J. Prakt. Chem. 336 (1994) 185-200. Conversion of isocyanates to uretdiones takes place generally in the presence of soluble dimerization catalysts, such as dialkylaminopyridines, trialkylphosphines, phosphor-amides or imidazoles, for example. The reaction, carried out optionally in solvents but preferably in their absence, is terminated by addition of catalyst poisons when a desired conversion has been reached. Excess monomeric isocyanate is separated off afterwards by short-path evaporation. If the catalyst is sufficiently volatile, the reaction mixture can be freed from the catalyst at the same time as monomer is separated off. In that case there is no need to add catalyst poisons. A broad range of isocyanates is suitable in principle for the preparation of polyisocyanates containing uretdione groups.

Preferred for use in accordance with the invention are isophorone diisocyanate (IPDI), hexamethylene diiso-cyanate (HDI), 2,2′-dicyclohexylmethane diisocyanate/2,4′-dicyclohexylmethane diisocyanate/4,4′-dicyclohexylmethane diisocyanate (H₁₂MDI), 2-methylpentane diisocyanate (MPDI), 2,2,4-trimethyl-hexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI). Very particular preference is given to IPDI, 4,4′-H₁₂MDI and HDI. It is of course also possible to use mixtures.

The conversion of these polyisocyanates carrying uretdione groups to curing agents A) with uretdione groups involves the reaction of the free NCO groups with hydroxyl-containing monomers or polymers, such as polyesters, polythioethers, polyethers, polycapro-lactones, polyepoxides, polyesteramides, polyurethanes or low molecular mass di-, tri- and/or tetraalcohols as chain extenders and, if desired, monoamines and/or monoalcohols as chain terminators, and has already been frequently described (EP 669 353, EP 669 354, DE 30 30 572, EP 639 598 or EP 803 524).

Preferred curing agents A) with uretdione groups have a free NCO content of less than 5% by weight and a uretdione group content of from 1% to 25% by weight, preferably 6% to 25% by weight (calculated as C₂N₂O₂, molecular weight 84). It is preferred to use polyesters having an OH number of from 30 to 150 mg KOH/g and an average molecular weight of from 500 to 6000 g/mol, or monomeric dialcohols, such as ethylene glycol, propane-1,2-diol and -1,3-diol, 2,2-dimethylpropane-1,3-diol, butane-1,4-diol, hexane-1,6-diol, 2-methylpentane-1,5-diol, 2,2,4-trimethylhexane-1,6-diol, 2,4,4-trimethyl-hexane-1,6-diol, heptane-1,7-diol, dodecane-1,12-diol, octadec-9-ene-1,12-diol, thiodiglycol, octadecane-1,18-diol, 2,4-dimethyl-2-propylheptane-1,3-diol, diethylene glycol, triethylene glycol, tetraethylene glycol, and trans- and cis-1,4-cyclohexanedimethanol, for example.

Besides uretdione groups, the curing agents A) may also have isocyanurate, biuret, allophanate, urethane and/or urea structures.

As hydroxyl-containing polymers B) use is made of polymers having an OH number of 20-500 mg KOH/gram, preferably 30 to 120 mg KOH/g, the polymer being based on at least one diol or polyol having at least one secondary OH group, and the fraction being at least 2 mol %, based on the alcohols employed.

At least one diol or polyol having at least one secondary alcohol group is mandatory in the polymers B). Examples recited are 1,2-propylene glycol, 2,3-butylene glycol, glycerol, hexan-1,2,6-triol and butan-1,2,4-triol. Particular preference is given to glycerol, alone or in mixtures. The fraction of the required alcohol with secondary OH groups must be at least 2 mol %, based on the alcohols employed. The fraction may also be 100 mol %. There is preferably 2 to 20 mol %, more preferably 3 to 10 mol %, of these alcohols in the polymers B).

Examples of suitable polymer B) include polyesters. The carboxylic acids preferred for the preparation of these polyesters may be aliphatic, cycloaliphatic, aromatic and/or heterocyclic in nature and may if desired be substituted by halogen atoms and/or unsaturated.

Examples thereof that may be mentioned include the following: succinic, adipic, suberic, azelaic, sebacic, phthalic, terephthalic, isophthalic, trimellitic, pyromellitic, tetrahydrophthalic, hexahydrophthalic, hexahydroterephthalic, di- and tetrachlorophthalic, endomethylenetetrahydrophthalic, glutaric, maleic and fumaric acid, and—where available—their anhydrides, dimethyl terephthalate, bisglycol terephthalate, and also cyclic monocarboxylic acid, such as benzoic acid, p-tert-butylbenzoic acid or hexahydrobenzoic acid. Suitable polyhydric alcohols include, for example, ethylene glycol, 1,2- and 1,3-propylene glycol, 1,4- and 2,3-butylene glycol, di-β-hydroxyethylbutanediol, 1,6-hexanediol, 1,8-octanediol, neopentyl glycol, cyclohexanediol, bishydroxymethylpropane, 2-methyl-propane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl)iso-cyanurate, pentaerythritol, mannitol and sorbitol and also diethylene glycol, triethylene glycol, tetra-ethylene glycol, dipropylene glycol, polypropylene glycol, polybutylene glycol, xylylene glycol and neopentyl glycol hydroxypivalate for the preparation of the polyester B).

Monoesters and polyesters of lactones as well, such as ε-caprolactone, or hydroxycarboxylic acids, such as hydroxypivalic acid, ε-hydroxydecanoic acid, ε-hydroxy-caproic acid and thioglycolic acid, can be used as starting materials for preparing the polymers B. Polyesters of the abovementioned polycarboxylic acids and/or their derivatives and polyphenols, such as hydroquinone, bisphenol A, 4,4′-dihydroxybiphenyl or bis(4-hydroxyphenyl) sulphone; polyesters of carbonic acid which are obtainable in a known way from hydro-quinone, diphenylolpropane, p-xylylene glycol, ethylene glycol, butanediol or hexane-1,6-diol and other polyols by typical condensation reactions, such as with phosgene or with diethyl carbonate or diphenyl carbonate, or from cyclic carbonates, such as glycol carbonate or vinylidene carbonate, by polymerization; polyesters of silicic acid, polyesters of phosphoric acid, such as from methane-, ethane-, β-chloroethane-, benzene- or styrene-phosphoric acid, esters or -phosphoryl chloride, and polyalcohols or polyphenols of the abovementioned kind; polyesters of boric acid; polysiloxanes, such as the products, for example, that are obtainable by hydrolysis of dialkyldichlorosilanes with water and subsequent treatment with polyalcohols, and also products obtainable by addition of polysiloxane dihydrides with olefins such as allyl alcohol or acrylic acid, are suitable starting materials for the preparation of the polymer B).

Further examples of preferred polyesters B) include the reaction products of polycarboxylic acids and glycidyl compounds, as described for example in DE-A 24 10 513.

Examples of glycidyl compounds that can be used are esters of 2,3-epoxy-1-propanol with monobasic acids having 4 to 18 carbon atoms, such as glycidyl palmitate, glycidyl laurate and glycidyl stearate, alkylene oxides having 4 to 18 carbon atoms, such as butylene oxide, and glycidyl ethers, such as octyl glycidyl ether.

The polyesters B) can be obtained in conventional manner by condensation in an inert gas atmosphere at temperatures from 100 to 260° C., preferably 130 to 220° C., in the melt or in an azeotropic procedure, as described for example in Methoden der Organischen Chemie (Houben-Weyl), volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

Further suitable polymers B) include hydroxy-functional polyethers and polycarbonates. Preferred polyethers can be prepared for example by polyaddition of epoxides, such as ethylene oxide, propylene oxide, butylene oxide, trimethylene oxide, 3,3-bis(chloromethyl)oxa-bicyclobutane, tetrahydrofuran, styrene oxide or the bis-2,5-epoxypropyl ether of diphenylolpropane, by cationic polymerization in the presence of Lewis acids, such as boron trifluoride, or by anionic polymerization with alkali metal hydroxides or alkali metal alkoxides, or by addition of these epoxides, if desired in a mixture or in succession, with starting components containing reactive hydrogen atoms, such as alcohols or amines, examples being water, ethylene glycol, polypropylene 1,3-glycol or 1,2-glycol, pentamethylene glycol, hexanediol, decamethylene glycol, trimethylol-propane, glycerol, aniline, ammonia, ethanolamine, ethylenediamine, di(β-hydroxypropyl)methylamine, and hydroxyalkylated phenols, such as di(β-hydroxyethoxy)-resorcinol, for example.

Exemplified polymers B) with carbonate groups can be obtained, as is known, by reaction of the exemplified dihydric or trihydric alcohols of the molecular weight range 62 to 300 with diaryl carbonates, such as diphenyl carbonate, phosgene or, preferably, cyclic carbonates, such as trimethylene carbonate or 2,2-dimethyltrimethylene carbonate (NPC), or with mixtures of such cyclic carbonates. Particularly preferred carbonate diols are those preparable from the stated dihydric alcohols as starter molecules and NPC with ring opening.

Further suitable examples of polymers B) are the polythioethers, polyacetals, polyepoxides, polyester-amides or polyurethanes of the molecular weight range 250 to 8500 g/mol which are known per se in polyurethane chemistry and which have hydroxyl groups that are reactive towards isocyanate groups.

It will be appreciated that mixtures of the aforementioned polymers B) can be used as well.

In the polyurethane compositions of the invention, the higher the Tg of these polymers, the more pronounced the differences between polymers B) which contain secondary alcohols and those which do not contain any. As a consequence, polymers B) based on secondary alcohols having a Tg of at least 45° C. are preferred. Even more preferred are those polymers B) with a Tg of at least 55° C., and the most-preferred polymers B) are those with a Tg of at least 60° C.

The proportion of A) to B), expressed by the NCO:OH ratio of these components, varies from 0.5:1 to 5:1 NCO:OH, preferably from 1:1 to 2.5:1 NCO:OH.

Also in accordance with the invention is the use of at least one catalyst C) which leads to increased uretdione group reactivity. These catalysts are preferably selected from the group of quaternary ammonium salts or phosphonium salts with carboxylates, hydroxides or halides as their counterion, or of metal hydroxides. Examples of such catalysts are as follows: tetramethylammonium formate, tetramethylammonium acetate, tetramethylammonium propionate, tetramethyl-ammonium butyrate, tetramethylammonium benzoate, tetraethylammonium formate, tetraethylammonium acetate, tetraethylammonium propionate, tetraethylammonium butyrate, tetraethylammonium benzoate, tetrapropyl-ammonium formate, tetrapropylammonium acetate, tetrapropylammonium propionate, tetrapropylammonium butyrate, tetrapropylammonium benzoate, tetrabutyl-ammonium formate, tetrabutylammonium acetate, tetrabutylammonium propionate, tetrabutylammonium butyrate and tetrabutylammonium benzoate, methyltributylammonium hydroxide, methyltriethyl-ammonium hydroxide, tetramethylammonium hydroxide, tetraethylammonium hydroxide, tetrapropylammonium hydroxide, tetrabutylammonium hydroxide, tetrapentyl-ammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethyl-ammonium hydroxide, benzyltriethylammonium hydroxide, trimethylphenylammonium hydroxide, triethylmethyl-ammonium hydroxide, trimethylvinylammonium hydroxide, tetramethylammonium fluoride, tetraethylammonium fluoride, tetrabutylammonium fluoride, tetraoctyl-ammonium fluoride and benzyltrimethylammonium fluoride, lithium hydroxide, sodium hydroxide, potassium hydroxide, rubidium hydroxide, caesium hydroxide, beryllium hydroxide, magnesium hydroxide, calcium hydroxide, strontium hydroxide, barium hydroxide, aluminium hydroxide, zinc hydroxide, tetrabutylammonium chloride, tetrabutylammonium bromide, tetrabutyl-ammonium iodide, tetraethylammonium chloride, tetraethylammonium bromide, tetraethylammonium iodide, tetramethylammonium chloride, tetramethylammonium bromide, tetramethylammonium iodide, benzyltrimethyl-ammonium chloride, benzyltriethylammonium chloride, benzyltripropylammonium chloride, benzyltributyl-ammonium chloride, methyltributylammonium chloride, methyltripropylammonium chloride, methyltriethyl-ammonium chloride, methyltriphenylammonium chloride, phenyltrimethylammonium chloride, benzyltrimethyl-ammonium bromide, benzyltriethylammonium bromide, benzyltrlpropylammonium bromide, benzyltributylammonium bromide, methyltributylammonium bromide, methyl-tripropylammonium bromide, methyltriethylammonium bromide, methyltriphenylammonium bromide, phenyl-trimethylammonium bromide, benzyltrimethylammonium iodide, benzyltriethylammonium iodide, benzyltri-propylammonium iodide, benzyltributylammonium iodide, methyltributylammonium iodide, methyltripropylammonium iodide, methyltriethylammonium iodide, methyltriphenyl-ammonium iodide and phenyltrimethylammonium iodide, tetrabutylphosphonium acetate, tetrabutylphosphonium benzotriazolate, tetrabutylphosphonium hydroxide, ethyltriphenylphosphonium acetate, tetraphenyl-phosphonium phenolate, trihexyltetradecylphosphonium decanoate and tetrabutylphosphonium fluoride. Particular preference is given to tetraethylammonium benzoate and/or tetrabutylammonium benzoate.

Also suitable, however, are catalysts as already described in WO 00/34355, such as metal acetyl-acetonates.

As examples mention may be made of lithium acetyl-acetonate and zinc acetylacetonate. Zinc acetyl-acetonate is particularly preferred.

It is of course also possible to use mixtures of such catalysts C). They are present in an amount from 0.001%-5% by weight, preferably 0.01%-3% by weight, with particular preference from 0.5% to 1.5% by weight, based on the total formulation of the constituents A)-F). The catalysts C) may be surrounded by an inert shell and hence encapsulated. The catalysts may contain water of crystallization, in which case this water is not taken into account when calculating the amount of catalyst used—in other words, the water quantity is subtracted from the calculation. One inventive version includes the polymeric attachment of such catalysts C) to the curing agent A) or to the hydroxyl-containing polymers B). Thus, for example, it is possible to react free alcohol, thio or amino groups of the ammonium salts with acid, isocyanate or glycidyl groups of the curing agents A) or hydroxyl-containing polymers B) in order to integrate the catalysts C) into the polymeric assembly.

It must be borne in mind in this context that in the presence of acids the activity of these catalysts goes down significantly whereas the storage stability goes up. The conventional reaction partners of the uretdione-containing curing agents include hydroxyl-containing polyesters. Because of the way in which polyesters are prepared, they occasionally still carry acid groups to a small extent. In the presence of polyesters which carry such acid groups it is appropriate either to use the aforementioned catalysts in excess, relative to the acid groups, or else to add reactive compounds which are capable of scavenging acid groups. Both monofunctional and polyfunctional compounds can be used for this purpose.

Reactive acid-scavenging compounds D) are common knowledge within paint chemistry. For example, epoxy compounds, carbodiimides, hydroxyalkylamides or 2-oxazolines, but also basic salts such as hydroxides, hydrogen carbonates or carbonates, react with acid groups at elevated temperatures. Suitable examples include triglycidyl ether isocyanurate (TGIC), EPIKOTE 828 (diglycidyl ether based on bisphenol A, Shell), Versatic acid glycidyl esters, ethylhexyl glycidyl ether, butyl glycidyl ether, POLYPOX R 16 (penta-erythritol tetraglycidyl ether, UPPC AG) and also other Polypox grades having free epoxy groups, β-hydroxyalkyl amides such as VESTAGON EP HA 320 (Degussa AG), but also phenylenebisoxazoline, 2-methyl-2-oxazoline, 2-hydroxyethyl-2-oxazoline, 2-hydroxypropyl-2-oxazoline, 5-hydroxypentyl-2-oxazoline, sodium carbonate and calcium carbonate. It will be appreciated that mixtures of such substances are also suitable. These reactive compounds can be used in weight fractions of from 0.1% to 10%, preferably from 0.5% to 3%, based on the total formulation.

Acids specified under E) are all substances—solid or liquid, organic or inorganic, monomeric or polymeric—which possess the properties of a Brønsted acid or a Lewis acid. Examples that may be mentioned include the following: sulphuric acid, acetic acid, benzoic acid, malonic acid, succinic acid, terephthalic acid, or else copolyesters or copolyamides having an acid number of at least 20. The fraction of these acids as a proportion of the total formulation, if they are present, can be from 0.01% to 20%, preferably from 0.1% to 5%.

For the polyurethane compositions it is possible to add auxiliaries and additives F) such as levelling agents, e.g. polysilicones or acrylates, light stabilizers, e.g. sterically hindered amines, or other auxiliaries, as described for example in EP 669 353, in a total amount of from 0.05% to 5% by weight. Fillers and pigments such as titanium dioxide, for example, can be added in an amount up to 50% by weight of the overall composition.

Optionally it is possible for there to be additional catalysts of the kind already known within polyurethane chemistry. These are, primarily, organometallic catalysts, such as dibutyltin dilaurate, or else tertiary amines, such as 1,4-diazabicyclo[2.2.2]octane, for example, in amounts of 0.001-1% by weight.

All of the constituents for preparing the polyurethane composition of the invention can be homogenized in suitable apparatus, such as heatable stirred tanks, kneading apparatus or else extruders, for example, in which upper temperature limits of 120 to 130° C. ought not to be exceeded. In the case of the solid formulations, the application of ready-to-spray powders to suitable substrates may take place by the known methods, such as by electrostatic powder spraying or by fluid-bed sintering, electrostatically or otherwise. Application is followed by heating of the coated workpieces, for the purpose of curing, at a temperature from 60 to 220° C. for 4 to 60 minutes, preferably at 80 to 160° C. for 6 to 30 minutes.

The subject matter of the invention is illustrated below with reference to examples.

### EXAMPLES

I. Ingredients:

TABLE 1

| Ingredients | Product description, manufacturer |
|---|---|
| VESTAGON BF 9030 | Curing agent, Degussa GmbH, Coatings & |
| | Colorants, uretdione content: 12.3%, |
| | m.p.: 74-75° C., T_{g}: 42° C. |
| TEAB | Tetraethylammonium benzoate, RSA Corp. |
| ARALDIT PT 912 | Epoxide, Huntsman acid scavenger |
| KRONOS 2160 | Titanium dioxide, Kronos, white |
| | pigment |
| RESIFLOW PV 88 | Worlee, levelling agent |
| BENZOIN | Aldrich, degassing agent |

m.p.: melting point;
T_{g}: glass transition point;

II. Polyester Preparation

Inventive Polyester A (Containing Secondary Alcohols)

Terephthalic acid (688 g, 4.1 mol), adipic acid (12.5 g, 0.1 mol), 2,2-dimethyl-1,3-propanediol (302 g, 2.9 mol), ethylene glycol (93 g, 1.5 mol) and glycerol (42 g, 0.5 mol) are melted under a stream of nitrogen in a 2 l flask with top-mounted distillation unit. When a temperature of 160° C. is reached, water begins to distil off. Over the course of an hour the temperature is successively raised to 220° C. After a further four hours at this temperature, the elimination of water slows down. 200 mg of titanium tetrabutoxide are stirred in, and reaction is continued under reduced pressure, which in the course of the reaction is adapted so that distillate continues to be produced all the time. When a hydroxyl number of 46 mg KOH/g (method: DIN 53240-2) and an acid number of 2.8 mg KOH/g (method: DIN EN ISO 2114) are reached, the system is shut down. The glass transition temperature of the polyester is 66° C. (DSC method, 2nd heating). Viscosity (120° C.): 1550 mPas.

Comparative Polyester B (Not Containing Secondary Alcohols)

Terephthalic acid (688 g, 4.1 mol), adipic acid (12.5 g, 0.1 mol), 2,2-dimethyl-1,3-propanediol (302 g, 2.9 mol), ethylene glycol (93 g, 1.5 mol) and trimethylolpropane (67 g, 0.5 mol) are melted under a stream of nitrogen in a 2 l flask with top-mounted distillation unit. When a temperature of 160° C. is reached, water begins to distil off. Over the course of an hour the temperature is successively raised to 240° C. After a further two hours at this temperature, the elimination of water slows down. 200 mg of titanium tetrabutoxide are stirred in, and reaction is continued under reduced pressure, which in the course of the reaction is adapted so that distillate continues to be produced all the time. When a hydroxyl number of 44 mg KOH/g (method: DIN 53240-2) and an acid number of 3.2 mg KOH/g (method: DIN EN ISO 2114) are reached, the system is shut down. The glass transition temperature of the polyester is 65° C. (DSC method, 2nd heating). Viscosity (120° C.): 1200 mPas.

Polyesters A and B are comparable on account of their similar composition.

Inventive Polyester C (Containing Secondary Alcohols)

Terephthalic acid (688 g, 4.1 mol), adipic acid (12.5 g, 0.1 mol), 2,2-dimethyl-1,3-propanediol (453 g, 4.4 mol) and glycerol (34 g, 0.4 mol) are melted under a stream of nitrogen in a 2 l flask with top-mounted distillation unit. When a temperature of 160° C. is reached, water begins to distil off. Over the course of an hour the temperature is successively raised to 220° C. After a further four hours at this temperature, the elimination of water slows down. 200 mg of titanium tetrabutoxide are stirred in, and reaction is continued under reduced pressure, which in the course of the reaction is adapted so that distillate continues to be produced all the time. When a hydroxyl number of 41 mg KOH/g (method: DIN 53240-2) and an acid number of 6.0 mg KOH/g (method: DIN EN ISO 2114) are reached, the system is shut down. The glass transition temperature of the polyester is 60° C. (DSC method, 2nd heating) Viscosity (120° C.): 910 mPas.

Comparative Polyester D (Not Containing Secondary Alcohols)

Terephthalic acid (688 g, 4.1 mol), adipic acid (12.5 g, 0.1 mol), 2,2-dimethyl-1,3-propanediol (453 g, 4.4 mol) and trimethylolpropane (54 g, 0.4 mol) are melted under a stream of nitrogen in a 2 l flask with top-mounted distillation unit. When a temperature of 160° C. is reached, water begins to distil off. Over the course of an hour the temperature is successively raised to 240° C. After a further four hours at this temperature, the elimination of water slows down. 200 mg of titanium tetrabutoxide are stirred in, and reaction is continued under reduced pressure, which in the course of the reaction is adapted so that distillate continues to be produced all the time. When a hydroxyl number of 42 mg KOH/g (method: DIN 53240-2) and an acid number of 5.8 mg KOH/g (method: DIN EN ISO 2114) are reached, the system is shut down. The glass transition temperature of the polyester is 61° C. (DSC method, 2nd heating). Viscosity (120° C.): 860 mPas.

Polyesters C and D are comparable on account of their similar composition.

III. Powder Coating Formulations (Amounts in % by Weight):

TABLE 2

| | Formulation | Formulation | Formulation | Formulation 4 |
|---|---|---|---|---|
| | 1 | 2 (non- | 3 | (non- |
| Examples | (inventive) | inventive) | (inventive) | inventive) |
| Vestagon BF | 21.5 | 20.8 | 19.8 | 20.1 |
| 9030 | | | | |
| Polyester A | 45.0 | | | |
| Polyester B | | 45.7 | | |
| Polyester C | | | 46.7 | |
| Polyester D | | | | 46.4 |
| TEAB | 0.5 | 0.5 | 0.5 | 0.5 |
| Araldit PT | 1.5 | 1.5 | 1.5 | 1.5 |
| 912 | | | | |
| Kronos 2160 | 30 | 30 | 30 | 30 |
| Benzoin | 0.5 | 0.5 | 0.5 | 0.5 |
| Resiflow PV | 1.0 | 1.0 | 1.0 | 1.0 |
| 88 | | | | |
| NCO:OH | 1.7:1 | 1.7:1 | 1.7:1 | 1.7:1 |

General preparation, powder coating formulations and powder coatings

The comminuted ingredients from Table 2 are intimately mixed in a preliminary mixer and then homogenized in an extruder at up to 130° C. maximum. The extrudate is cooled, fractionated and ground on a pinned-disc mill to a particle size<63 μm. This is followed by electrostatic spray application to standard steel panels (film thickness 70-90 μm) and by curing in an oven at 150° C. for 30 minutes.

Testing of the cured films gave the results below, contained in Table 3:

IV. Results

TABLE 3

| | | | Ball impact | Levelling |
|---|---|---|---|---|
| | | Cupping | (dir/indir) | PCI |
| Examples | Storage | [mm] | [inch × lbs] | (1 poor, 10 good) |
| 1 | none | >10 | 160/160 | 4 |
| 1 | 1 w 40° C. | >10 | 160/100 | 3-4 |
| 2* | none | >10 | 140/120 | 4 |
| 2* | 1 w 40° C. | >10 | 80/60 | 1 |
| 3 | none | >10 | 120/160 | 5 |
| 3 | 1 w 40° C. | >10 | 160/140 | 4 |
| 4* | none | >10 | 90/50 | 5 |
| 4* | 1 w 40° C. | >10 | 60/20 | 3 |

*non-inventive, comparative examples

Cupping to DIN 53156, ball impact to ASTM D 2794-93

On the basis of the comparable polyester composition, 1 must be compared with 2*, and 3 with 4*. All of the powder coating formulations cure fully at 150° C. in 30 minutes, but only the inventive formulations display a good balance between their reactivity at 150° C. and their storage stability after one week at 40° C. In particular, not only the ball impact but also the levelling with and without storage is (significantly) better in the case of the inventive compositions than in the case of the comparable non-inventive compositions.

1. A high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

2. A polyurethane composition according to claim 1, characterized in that
D) there is at least one compound which is reactive towards acid groups and has a weight fraction, based on the overall formulation, of from 0.1% to 10% by weight and/or
E) there is at least one acid in monomeric or polymeric form, in a weight fraction, based on the overall formulation, of from 0.01% to 20%.

3. A polyurethane composition according to claim 1 or 2, characterized in that there are auxiliaries and additives F).

4. A polyurethane composition according to at least one of the preceding claims, characterized in that there are curing agents A), with uretdione groups, based on isophorone diisocyanate (IPDI), hexamethylene diisocyanate (HDI), 2,2′-dicyclo-hexylmethane diisocyanate/2,4′-dicyclohexylmethane diisocyanate/4,4′-dicyclohexylmethane diisocyanate (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI), alone or in a mixture.

5. A polyurethane composition according to claim 4, characterized in that there are curing agents A), with uretdione groups, based on IPDI, 4,4′-H₁₂MDI and/or HDI.

6. A polyurethane composition according to at least one of the preceding claims, characterized in that there are curing agents A), with uretdione groups, based on hydroxyl-containing polyesters, polythioethers, polyethers, polycaprolactones, polyepoxides, polyesteramides, polyurethanes, low molecular mass di-, tri- and/or tetraalcohols, monoamines and/or monoalcohols, alone or in a mixture.

7. A polyurethane composition according to claim 6, characterized in that there are polyesters and/or monomeric dialcohols.

8. A polyurethane composition according to at least one of the preceding claims, characterized in that the curing agents A) with uretdione groups have a free NCO content of less than 5% by weight and a uretdione group content of 6% to 25% by weight (calculated as C₂N₂O₂, molecular weight 84).

9. A polyurethane composition according to at least one of the preceding claims, characterized in that the hydroxyl-containing polymers B) contain alcohols with secondary OH groups, selected from 1,2-propylene glycol, 2,3-butylene glycol, glycerol, hexane-1,2,6-triol and butane-1,2,4-triol, alone or in a mixture.

10. A polyurethane composition according to claim 9, characterized in that there is glycerol as alcohol, alone or in a mixture.

11. A polyurethane composition according to at least one of the preceding claims, characterized in that there are polymers B) having an OH number of from 30 to 120 mg KOH/g.

12. A polyurethane composition according to at least one of the preceding claims, characterized in that there are polyesters as polymers B).

13. A polyurethane composition according to at least one of the preceding claims, characterized in that there are polymers B) based on secondary alcohols, having a Tg of at least 45° C.

14. A polyurethane composition according to at least one of the preceding claims, characterized in that there are polymers B) having a Tg of at least 55° C.

15. A polyurethane composition according to at least one of the preceding claims, characterized in that there are polymers B) having a Tg of at least 60° C.

16. A polyurethane composition according to at least one of the preceding claims, characterized in that there are catalysts from the group of quaternary ammonium salts or phosphonium salts with carboxylates, hydroxides or halides as counterion, or of metal hydroxides.

17. A polyurethane composition according to at least one of the preceding claims, characterized in that there are catalysts C) selected from tetramethyl-ammonium formate, tetramethylammonium acetate, tetramethylammonium propionate, tetramethyl-ammonium butyrate, tetramethylammonium benzoate, tetraethylammonium formate, tetraethylammonium acetate, tetraethylammonium propionate, tetra-ethylammonium butyrate, tetraethylammonium benzoate, tetrapropylammonium formate, tetra-propylammonium acetate, tetrapropylammonium propionate, tetrapropylammonium butyrate, tetra-propylammonium benzoate, tetrabutylammonium formate, tetrabutylammonium acetate, tetrabutyl-ammonium propionate, tetrabutylammonium butyrate and tetrabutylammonium benzoate, methyltributyl-ammonium hydroxide, methyltriethylammonium hydroxide, tetramethylammonium hydroxide, tetra-ethylammonium hydroxide, tetrapropylammonium hydroxide, tetrabutylammonium hydroxide, tetrapentylammonium hydroxide, tetrahexylammonium hydroxide, tetraoctylammonium hydroxide, tetra-decylammonium hydroxide, tetradecyltrihexyl-ammonium hydroxide, tetraoctadecylammonium hydroxide, benzyltrimethylammonium hydroxide, benzyltriethylammonium hydroxide, trimethylphenyl-ammonium hydroxide, triethylmethylammonium hydroxide, trimethylvinylammonium hydroxide, tetramethylammonium fluoride, tetraethylammonium fluoride, tetrabutylammonium fluoride, tetraoctyl-ammonium fluoride and benzyltrimethylammonium fluoride, lithium hydroxide, sodium hydroxide, potassium hydroxide, rubidium hydroxide, caesium hydroxide, beryllium hydroxide, magnesium hydroxide, calcium hydroxide, strontium hydroxide, barium hydroxide, aluminium hydroxide, zinc hydroxide, tetrabutylammonium chloride, tetra-butylammonium bromide, tetrabutylammonium iodide, tetraethylammonium chloride, tetraethylammonium bromide, tetraethylammonium iodide, tetramethyl-ammonium chloride, tetramethylammonium bromide, tetramethylammonium iodide, benzyltrimethyl-ammonium chloride, benzyltriethylammonium chloride, benzyltripropylammonium chloride, benzyltributylammonium chloride, methyltributyl-ammonium chloride, methyltripropylammonium chloride, methyltriethylammonium chloride, methyl-triphenylammonium chloride, phenyltrimethyl-ammonium chloride, benzyltrimethylammonium bromide, benzyltriethylammonium bromide, benzyl-tripropylammonium bromide, benzyltributylammonium bromide, methyltributylammonium bromide, methyl-tripropylammonium bromide, methyltriethylammonium bromide, methyltriphenylammonium bromide, phenyl-trimethylammonium bromide, benzyltrimethylammonium iodide, benzyltriethylammonium iodide, benzyltri-propylammonium iodide, benzyltributylammonium iodide, methyltributylammonium iodide, methyltri-propylammonium iodide, methyltriethylammonium iodide, methyltriphenylammonium iodide and phenyl-trimethylammonium iodide, tetrabutylphosphonium acetate, tetrabutylphosphonium benzotriazolate, tetrabutylphosphonium hydroxide, ethyltriphenyl-phosphonium acetate, tetraphenylphosphonium phenolate, trihexyltetradecylphosphonium decanoate and tetrabutylphosphonium fluoride.

18. A polyurethane composition according to at least one of the preceding claims, characterized in that there is tetraethylammonium benzoate and/or tetra-butylammonium benzoate as catalyst C).

19. A polyurethane composition according to at least one of the preceding claims 1 to 15, characterized in that as catalysts there are metal acetyl-acetonates, especially lithium acetylacetonate and/or zinc acetylacetonate.

20. A polyurethane composition according to at least one of the preceding claims, the catalysts C) being surrounded by an inert shell and hence encapsulated.

21. A polyurethane composition according to at least one of the preceding claims, characterized in that as component D) there are epoxy compounds, carbo-diimides, hydroxyalkylamides, basic salts and/or 2-oxazolines.

22. A polyurethane composition according to claim 18, characterized in that there are triglycidyl ether isocyanurate, EPIKOTE® 828, Versatic acid glycidyl esters, β-hydroxyalkylamides, phenylenebis-oxazoline, 2-methyl-2-oxazoline, 2-hydroxyethyl-2-oxazoline, 2-hydroxypropyl-2-oxazoline and/or 5-hydroxypentyl-2-oxazoline, sodium carbonate or calcium carbonate, alone or in a mixture.

23. A polyurethane composition according to at least one of the preceding claims, characterized in that as acid E) there are sulphuric acid, acetic acid, benzoic acid, malonic acid, terephthalic acid, but also copolyesters or copolyamides having an acid number of at least 20.

24. A process for preparing a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

25. Use of a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation
for preparing a pulverulent coating or adhesive composition.

26. Use according to claim 25, characterized in that there are starting compounds according to at least one of claims 2 to 23.

27. Use according to claim 25 or 26 for producing a pulverulent coating or adhesive composition for metal, plastic, wood, glass, MDF, leather or other heat-resistant substrate.

28. A metal-coating composition containing a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

29. A wood-coating composition containing a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

30. A leather-coating composition containing a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

31. A plastic-coating composition containing a high-reactivity polyurethane composition with uretdione groups, essentially containing
A) at least one curing agent with uretdione groups which is based on aromatic, aliphatic, (cyclo)aliphatic or cycloaliphatic polyiso-cyanates and hydroxyl-containing compounds and has a free NCO content of less than 5% by weight and a uretdione content of 1-25% by weight,
B) at least one hydroxyl-containing polymer having an OH number of from 20 to 500 mg KOH/gram, which is based on at least one diol or polyol having at least one secondary OH group, and the fraction is at least 2 mol %, based on the alcohols employed,
C) at least one catalyst which leads to increased uretdione group reactivity,
such that the fraction of the catalyst under C) is 0.001-5% by weight, based on the overall formulation.

32. A metal coating according to claim 25 for an automobile body, motorbike, cycle, architectural component or household appliance.

33. A coating composition according to any one of claims 28 to 32, characterized in that there is at least one of components D) to F).

34. A coating composition according to any one of claims 28 to 33, characterized in that it contains a compound according to at least one of claims 2 to 23.

35. A polyurethane composition according to at least one of the preceding claims 1-23, characterized in that the proportion of A) to B), expressed by the NCO:OH ratio of these components, varies from 0.5:1 to 5:1 NCO:OH, preferably from 1:1 to 2.5:1 NCO:OH.
